(19) United States
(12) Patent Application Publication
(10) Pub. No.: US 2017/0268454 A1
(43) Pub. Date: Sep. 21, 2017

(54) CONTROL DEVICE AND CONTROL METHOD FOR VEHICLE

(71) Applicant: Toyota Jidosha Kabushiki Kaisha, Toyota-shi Aichi-ken (JP)

(72) Inventors: Tatsuya Fujii, Nagakute-shi Aichi-ken (JP); Takeshi Genko, Nisshin-shi Aichi-ken (JP); Seiji Hino, Nisshin-shi Aichi-ken (JP)

(21) Appl. No.: 15/456,728

(22) Filed: Mar. 13, 2017

(30) Foreign Application Priority Data
Mar. 16, 2016 (JP) 2016-052623

(51) Int. Cl. F02D 41/40; F02D 41/30

(52) U.S. Cl. CPC F02D 41/40; F02D 41/3082; F02D 2041/389

(57) ABSTRACT

A smoothing coefficient is set value such that a value of smoothing coefficient when the fuel pressure difference is larger than the threshold value is larger than a value of smoothing coefficient when a fuel pressure difference between a target fuel pressure and a detected fuel pressure is equal to or smaller than a threshold value. A smoothened fuel pressure is calculated by performing fuel pressure smoothing processing on the detected fuel pressure, using the smoothing coefficient. An in-cylinder injection valve is controlled such that fuel is injected during a target fuel injection duration according to the smoothened fuel pressure from the in-cylinder injection valve.

### CROSS-REFERENCE TO RELATED APPLICATIONS

This application claims priority to Japanese Patent Application No. 2016-052623 filed on Mar. 16, 2016, which is incorporated herein by reference in its entirety including the specification, drawings and abstract.

### BACKGROUND

1. Technical Field

The present disclosure relates to a control device and a control method for a vehicle, and particularly, a vehicle equipped with an engine having in-cylinder injection valves, and a fuel supply device.

2. Description of Related Art

In the related art, as this type of vehicle, a vehicle equipped an engine having an in-cylinder injection valve that injects fuel into a cylinder, and a fuel supply device that supplies the fuel from a fuel tank to the engine is suggested (for example, refer to Japanese Patent Application Publication No. 2007-297922 (JP 2007-297922 A)). Here, the fuel supply device is equipped with a high-pressure fuel pump that is driven with the power from the engine, such as the rotation of a cam shaft to pressurizes the fuel from the fuel tank and supplies the pressurized fuel to a delivery pipe to which the in-cylinder injection valve is connected, and a fuel supply device that has a return passage that returns a portion of the fuel in the delivery pipe to the fuel tank. In this vehicle, a fuel pressure (smoothened fuel pressure) subjected to smoothing processed is calculated as an average value of an actual fuel pressure from a fuel pressure sensor that detects the fuel pressure of the fuel to be supplied to the in-cylinder injection valve, a final fuel injection quantity is set by correcting a basic fuel injection quantity on the basis of the smoothened fuel pressure, and driving of the in-cylinder injection valve is controlled on the basis of this final fuel injection quantity.

### SUMMARY

In such a vehicle, when the actual fuel pressure from the fuel pressure sensor is low like immediately after the start of operation of the engine, the fuel pressure within the delivery pipe is rapidly raised at a large rising rate by the high-pressure fuel pump. Additionally, since the rotation speed of the engine is relatively low immediately after the start of operation of the engine, the cycle of pulsation of the fuel pressure within the delivery pipe becomes long. For these reasons, the discrepancy between the actual fuel pressure and the smoothened fuel pressure is apt to become large. If this discrepancy becomes large, the air-fuel ratio may be disturbed and the discharge amount of particulate matter may increase.

The vehicle of the disclosure suppresses an increase in the discharge amount of particulate matter.

An example aspect of the present disclosure provides a control device for a vehicle. The vehicle includes an engine including an in-cylinder injection valve configured to inject fuel into a cylinder, a fuel supply device including a high-pressure fuel pump configured to pressurize the fuel from a fuel tank to supply a pressurized fuel to a supply flow passage to which the in-cylinder injection valve is connected, and a fuel pressure sensor configured to detect fuel pressure of the fuel in the in-cylinder injection valve as a detected fuel pressure. The control device includes an electronic control unit configured to i) control the high-pressure fuel pump such that the fuel pressure of the fuel in the in-cylinder injection valve reaches a target fuel pressure, during operation of the engine, ii) perform smoothing processing on the detected fuel pressure to calculate a smoothened fuel pressure such that a followability of the smoothened fuel pressure with respect to a change in the detected fuel pressure when a difference between the target fuel pressure and the detected fuel pressure is large is higher than a followability of the smoothened fuel pressure with respect to a change in the detected fuel pressure when the difference between the target fuel pressure and the detected fuel pressure is small, during the operation of the engine, iii) set a target fuel injection duration of the in-cylinder injection valve based on the smoothened fuel pressure during the operation of the engine, and iv) control the engine such that fuel injection is performed from the in-cylinder injection valve during the target fuel injection duration. An example aspect of the present disclosure provides a control method for a vehicle. The vehicle includes an engine including an in-cylinder injection valve configured to inject fuel into a cylinder, a fuel supply device including a high-pressure fuel pump configured to pressurize the fuel from a fuel tank to supply a pressurized fuel to a supply flow passage to which the in-cylinder injection valve is connected, a fuel pressure sensor configured to detect fuel pressure of the fuel in the in-cylinder injection valve as a detected fuel pressure, and an electronic control unit. The control method includes i) controlling the high-pressure fuel pump by the electronic control unit such that the fuel pressure of the fuel in the in-cylinder injection valve reaches a target fuel pressure, during operation of the engine, ii) performing smoothing processing on the detected fuel pressure to calculate a smoothened fuel pressure by the electronic control unit such that a followability of the smoothened fuel pressure with respect to a change in the detected fuel pressure when a difference between the target fuel pressure and the detected fuel pressure is large is higher than a followability of the smoothened fuel pressure with respect to a change in the detected fuel pressure when the difference between the target fuel pressure and the detected fuel pressure is small, during the operation of the engine, iii) setting a target fuel injection duration of the in-cylinder injection valve by the electronic control unit based on the smoothened fuel pressure, during the operation of the engine, and iv) controlling the engine by the electronic control unit such that fuel injection is performed from the in-cylinder injection valve during the target fuel injection duration.

In the vehicle of this disclosure, the target fuel injection duration of the in-cylinder injection valve is set by the electronic control unit based on the smoothened fuel pressure obtained by performing the smoothing processing on the detected fuel pressure detected by the fuel pressure sensor, and the electronic control is configured to control the engine such that fuel injection is performed from the in-cylinder injection valve during the target fuel injection duration. In this case, the smoothing processing is performed on the detected fuel pressure to calculate the smoothened fuel pressure such that the followability of the smoothened fuel pressure with respect to the change in the detected fuel pressure when the difference between the target fuel pressure to the fuel to be supplied to the in-cylinder injection valve and the detected fuel pressure is large is higher than that when the difference between the target fuel pressure and the detected fuel pressure is small. Since it can be believed that when the difference between the target fuel pressure and detected fuel pressure is large is when the operation of the engine is started and the pressure of the fuel to be supplied to the in-cylinder injection valve increases rapidly toward the target fuel pressure, an increase in the discrepancy between the detected fuel pressure and the smoothened fuel pressure can be suppressed by making the followability of the smoothened fuel pressure with respect to the detected fuel pressure high. As a result, disturbance of the air-fuel ratio can be suppressed, and an increase in the discharge amount of particulate matter can be suppressed. Additionally, since it can be believed that when the difference between the target fuel pressure and detected fuel pressure is small is when the pressure of the fuel to be supplied to the in-cylinder injection valve is around the target fuel pressure, fluctuation of the smoothened fuel pressure resulting from fluctuation of the detected fuel pressure can be further suppressed by making the followability of the smoothened fuel pressure with respect to the detected fuel pressure low. As a result, fluctuation of the target fuel injection duration can be suppressed, and disturbance of the air-fuel ratio can be suppressed, and an increase in the discharge amount of particulate matter can be suppressed.

An example aspect of the present disclosure provides a control device for a vehicle, the vehicle including an engine including an in-cylinder injection valve configured to inject fuel into a cylinder, a fuel supply device including a high-pressure fuel pump configured to pressurize the fuel from a fuel tank to supply a pressurized fuel to a supply flow passage to which the in-cylinder injection valve is connected, and a fuel pressure sensor configured to detect fuel pressure of the fuel in the in-cylinder injection valve as a detected fuel pressure. The control device includes an electronic control unit configured to i) control the high-pressure fuel pump such that the fuel pressure of the fuel in the in-cylinder injection valve reaches a target fuel pressure, during operation of the engine, ii) perform smoothing processing on the detected fuel pressure to calculate a smoothened fuel pressure such that a followability of the smoothened fuel pressure with respect to a change in the detected fuel pressure when a rotation speed of the high-pressure fuel pump is small is higher than a followability of the smoothened fuel pressure with respect to a change in the detected fuel pressure when the rotation speed of the high-pressure fuel pump is large, during the operation of the engine, iii) set a target fuel injection duration of the in-cylinder injection valve based on the smoothened fuel pressure during the operation of the engine, and iv) control the engine such that fuel injection is performed from the in-cylinder injection valve during the target fuel injection duration. An example aspect of the present disclosure provides a control method for a vehicle. The vehicle includes an engine including an in-cylinder injection valve configured to inject fuel into a cylinder, a fuel supply device including a high-pressure fuel pump configured to pressurize the fuel from a fuel tank to supply a pressurized fuel to a supply flow passage to which the in-cylinder injection valve is connected, a fuel pressure sensor configured to detect fuel pressure of the fuel in the in-cylinder injection valve as a detected fuel pressure, and an electronic control unit. The control method includes i) controlling the high-pressure fuel pump by the electronic control unit such that the fuel pressure of the fuel in the in-cylinder injection valve reaches a target fuel pressure, during operation of the engine, ii) performing smoothing processing on the detected fuel pressure to calculate a smoothened fuel pressure by the electronic control unit such that a followability of the smoothened fuel pressure with respect to a change in the detected fuel pressure when a rotation speed of the high-pressure fuel pump is small is higher than a followability of the smoothened fuel pressure with respect to a change in the detected fuel pressure when the rotation speed of the high-pressure fuel pump is large, during the operation of the engine, iii) setting a target fuel injection duration of the in-cylinder injection valve by the electronic control unit based on the smoothened fuel pressure, during the operation of the engine, and iv) controlling the engine by the electronic control unit such that fuel injection is performed from the in-cylinder injection valve during the target fuel injection duration.

In the vehicle of this disclosure, the target fuel injection duration of the in-cylinder injection valve is set by the electronic control unit based on the smoothened fuel pressure obtained by performing the smoothing processing on the detected fuel pressure detected by the fuel pressure sensor, and the electronic control unit is configured to control the engine such that fuel injection is performed from the in-cylinder injection valve during the target fuel injection duration. In this case, the smoothing processing is performed on the detected fuel pressure to calculate the smoothened fuel pressure such that the followability of the smoothened fuel pressure with respect to the change in the detected fuel pressure when the rotation speed of the high-pressure fuel pump is slow is higher than that when the rotation speed of the high-pressure fuel pump is fast. Since it can be believed that when the rotation speed of the high-pressure fuel pump is slow is when the operation of the engine is started and the pressure of the fuel to be supplied to the in-cylinder injection valve increases rapidly toward the target fuel pressure, an increase in the discrepancy between detected fuel pressure and the smoothened fuel pressure can be suppressed by making the followability of the smoothened fuel pressure with respect to the detected fuel pressure high. As a result, disturbance of the air-fuel ratio can be suppressed, and an increase in the discharge amount of particulate matter can be suppressed. Additionally, since it can be believed that when the rotation speed of the high-pressure fuel pump is fast is when the pressure of the fuel to be supplied to the in-cylinder injection valve is around the target fuel pressure, fluctuation of the smoothened fuel pressure resulting from fluctuation of the detected fuel pressure can be further suppressed by making the followability of the smoothened fuel pressure with respect to the detected fuel pressure low. As a result, fluctuation of the target fuel injection duration can be suppressed, and disturbance of the air-fuel ratio can be suppressed, and an increase in the discharge amount of particulate matter can be suppressed.

The vehicle may include a drive motor, and the electronic control unit may be configured to control the engine and the drive motor such that the vehicle travels while the engine performs intermittent operation. In the vehicle that performs driving with the intermittent operation of the engine, the frequency of switching between the operation and the stop of the engine increases as compared to a vehicle that performs driving only using the power from the engine without having the drive motor. Therefore, the importance of changing the followability of the smoothened fuel pressure with respect to the change in the detected fuel pressure according to the difference between the target fuel pressure and the detected fuel pressure or the rotation speed of the high-pressure fuel pump is larger.

In the vehicle of the disclosure, the fuel supply device may include a return flow passage that returns a portion of the fuel in the supply flow passage to the fuel tank, in addition to the fuel pump. In this configuration, the fuel pressure of the fuel to be supplied to the in-cylinder injection valve when the fuel in the supply flow passage returns to the fuel tank via a return flow passage at the time of the stop of the engine is apt to drop. Therefore, the importance of changing the followability of the smoothened fuel pressure with respect to the change in the detected fuel pressure according to the difference between the target fuel pressure and the detected fuel pressure or the rotation speed of the high-pressure fuel pump is larger.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration view illustrating the outline of the configuration of a hybrid vehicle as an embodiment of the disclosure;

FIG. 2 is a configuration view illustrating the outline of the configuration of an engine;

FIG. 3 is a flowchart illustrating an example of a fuel pressure smoothing processing routine to be executed by an engine ECU of the embodiment;

FIG. 4 is an explanatory view illustrating an aspect when a detected fuel pressure Pfdet is sufficiently low as compared to a target fuel pressure and the detected fuel pressure rises rapidly while pulsating;

FIG. 5 is an explanatory view illustrating an aspect when the detected fuel pressure Pfdet pulsates around the target fuel pressure;

FIG. 6 is an explanatory view illustrating an example of a fuel pressure smoothing processing routine of a modification example;

FIG. 7 is a configuration view illustrating the outline of the configuration of a hybrid vehicle of a modification example; and

FIG. 8 is a configuration view illustrating the outline of the configuration of a vehicle of a modification example.

### DETAILED DESCRIPTION OF EMBODIMENTS

Next, modes for carrying out the disclosure will be described using embodiments.

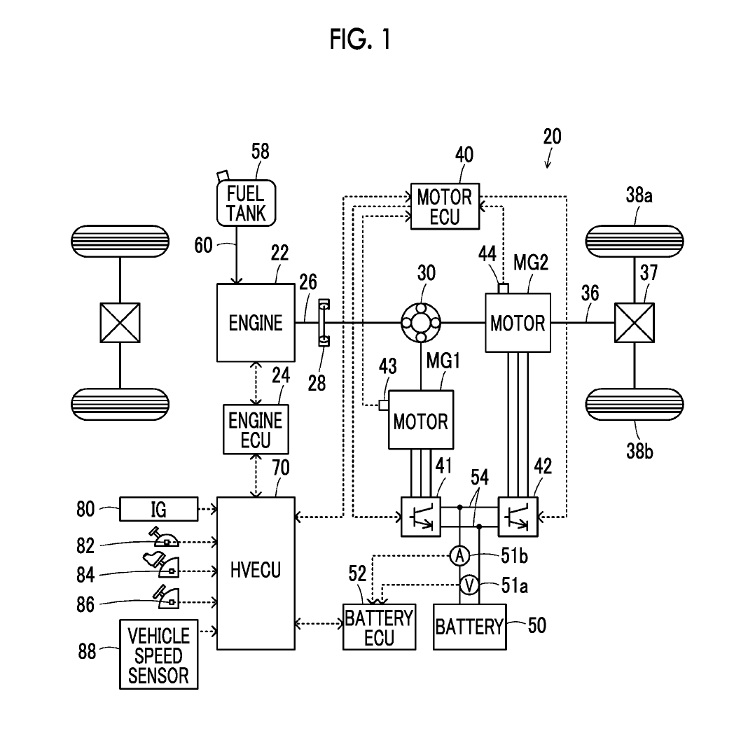

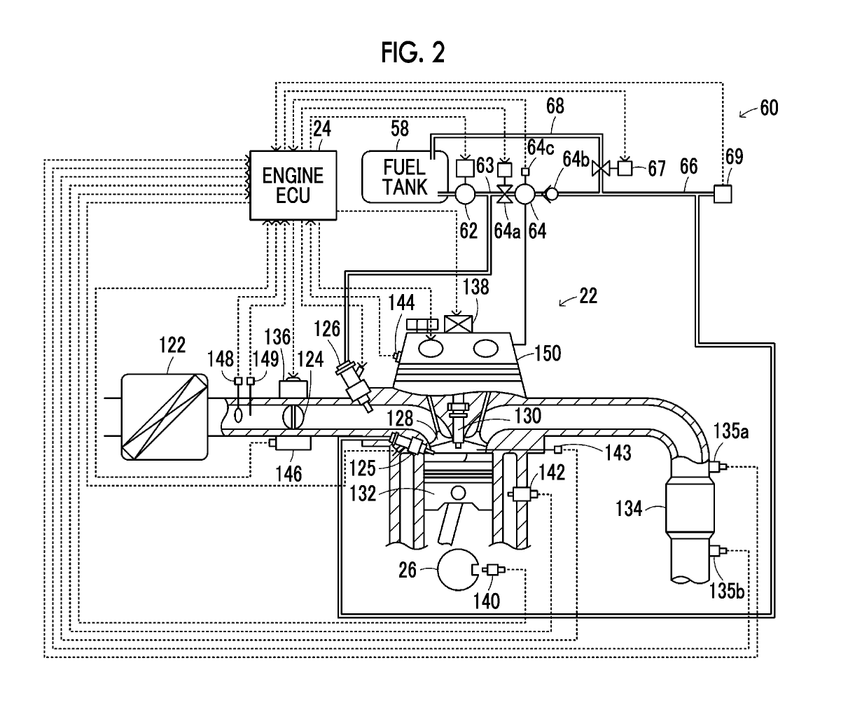

FIG. 1 is a configuration view illustrating the outline of the configuration of a hybrid vehicle 20 as an embodiment of the disclosure, and FIG. 2 is a configuration view illustrating the outline of the configuration of an engine 22. As illustrated in FIG. 1, the hybrid vehicle 20 of the embodiment includes the engine 22, a fuel supply device 60, a planetary gear 30, motors MG1, MG2, inverters 41, 42, a battery 50, and a hybrid vehicle electronic control unit 70 (hereinafter referred to as “HVECU”).

The engine 22 is constituted as an internal combustion engine that outputs power by using fuel, such as gasoline or gas oil. As illustrated in FIG. 2, an engine 22 has an in-cylinder injection valve 125 that injects fuel into a cylinder, and a port injection valve 126 that injects fuel into an intake port. The engine 22 can be operated in any of a port injection mode, a cylinder injection mode, and a common injection mode by having the in-cylinder injection valve 125 and the port injection valve 126. In the port injection mode, air and fuel are mixed by taking in the air purified by an air cleaner 122 via a throttle valve 124 and injecting fuel from the port injection valve 126. Then, this air-fuel mixture is taken into a combustion chamber via an intake valve 128, and is exploded and combusted by the spark caused by an ignition plug 130, and a reciprocal motion of a piston 132 pushed down by the energy of the explosion and combustion is converted into a rotational motion of a crankshaft 26. In the cylinder injection mode, the rotational motion of the crankshaft 26 is obtained by taking air into the combustion chamber similar to the port injection mode, injecting fuel from the in-cylinder injection valve 125 in the middle of an intake stroke or after reaching a compression stroke, and performing explosive combustion with the spark caused by the ignition plug 130. In the common injection mode, the rotational motion of the crankshaft 26 is obtained by injecting fuel from the port injection valve 126 and injecting fuel from the in-cylinder injection valve 125 in the intake stroke or a compression stroke when taken air into the combustion chamber, and performing explosive combustion with the spark caused by the ignition plug 130. Such injection modes are switched on the basis of the operational state of the engine 22. The exhaust air from the combustion chamber is discharged to ambient air via an exhaust gas control apparatus 134 having a purifying catalyst (three-way catalyst) that purifies harmful components of carbon monoxide (CO), hydrocarbon (HC), and or nitrogen oxides (NOx).

The fuel supply device 60 is constituted as a device that supplies the fuel of a fuel tank 58 to the in-cylinder injection valve 125 or the port injection valve 126 of the engine 22. The fuel supply device 60 is equipped with an electric fuel pump 62 that supplies the fuel of the fuel tank 58 to a fuel pipe 63 to which the port injection valve 126 is connected, and a high-pressure fuel pump 64 that pressurizes the fuel within the fuel pipe 63 to supply the fuel to a delivery pipe 66 to which the in-cylinder injection valve 125 is connected. Additionally, the fuel supply device 60 is equipped with a relief valve 67 that is provided in the relief pipe 68 connected to the delivery pipe 66 and the fuel tank 58 and is capable of reducing the pressure (hereinafter referred to as fuel pressure) of the pressurized fuel within the delivery pipe 66 due to a pressure difference from the atmospheric pressure. The high-pressure fuel pump 64 is a pump that is driven by the power (the rotation of a cam shaft) from the engine 22, and pressurizes the fuel within the fuel pipe 63. The high-pressure fuel pump 64 has a magnetic valve 64a that is connected to a suction port thereof and is opened and closed when pressurizing fuel, and a check valve 64b that is connected to a discharge port to prevent a back flow of fuel, and holds the fuel pressure within the delivery pipe 66. Accordingly, the high-pressure fuel pump 64 suctions the fuel from the fuel pump 62 if the magnetic valve 64a is open during the operation of engine 22, and pressurizes the fuel to be supplied to the delivery pipe 66 by intermittently sending, into the delivery pipe 66, the fuel compressed by a plunger (not illustrated) that operates with the power from the engine 22 via the check valve 64b when the magnetic valve 64a is closed. In addition, the fuel pressure within the delivery pipe 66 pulsates according to the rotation of the engine 22, that is, the rotation of the cam shaft. The relief valve 67 is a magnetic valve that prevents the fuel pressure within the delivery pipe 66 from becoming excessive and is open such that the fuel pressure within the delivery pipe 66 is lowered at the stop of the engine 22. If the relief valve 67 is open, the fuel within the delivery pipe 66 is returned to the fuel tank 58 via the relief pipe 68.

The operation of the engine 22 is controlled by an electronic control unit 24 for an engine (hereinafter referred to as an “engine ECU”). Although not illustrated, the engine ECU 24 is constituted as a microprocessor centered on a central processing unit (CPU), and includes, in addition to the CPU, a read-only memory (ROM) that stores a processing program, a read access memory (RAM) that temporarily stores data, input and output ports, and communication ports.

Signals from various sensors required to control the operation of the engine 22 are input to the engine ECU 24 via input ports. The signals to be input to the engine ECU 24 may include, for example, a crank position θcr from a crank position sensor 140 that detects the rotational position of the crankshaft 26, a cooling water temperature Tw from a water temperature sensor 142 that detects the temperature of cooling water of the engine 22, and the like. Additionally, the above signals may also include an in-cylinder pressure Pin from a pressure sensor 143 attached to the combustion chamber, a cam angle θca from a cam position sensor 144 that detects the rotational position of an intake cam shaft that opens and closes the intake valve 128 or the rotational position of an exhaust cam shaft that opens and closes an exhaust valve. Moreover, the above signal may also include a throttle opening degree TH from a throttle valve position sensor 146 that detects the position of the throttle valve 124, an intake air quantity Qa from an air flow meter 148 attached to an intake pipe, and an intake air temperature Ta from a temperature sensor 149 attached to the intake pipe, and the like. In addition, the above signals may include an air-fuel ratio AF from an air-fuel ratio sensor 135a attached to an exhaust pipe, an oxygen signal O2 from an oxygen sensor 135b attached to the exhaust pipe, and the like. Additionally, the above signal may also includes a rotation speed Np from a rotation speed sensor 64c that detects the rotation speed of the high-pressure fuel pump 64, a fuel pressure Pf (hereinafter referred to as a “detected fuel pressure Pfdet”) from a fuel pressure sensor 69 that detects the fuel pressure (fuel pressure of the fuel to be supplied to the in-cylinder injection valve 125) within the delivery pipe 66 of the fuel supply device 60, and the like.

Various control signals for controlling the operation of the engine 22 are output from the engine ECU 24 via the output ports. The signals to be output from the engine ECU 24 may include, for example, a driving signal to the in-cylinder injection valve 125, a driving signal to the port injection valve 126, a driving signal to a throttle motor 136 that adjusts the position of the throttle valve 124, a control signal to an ignition coil 138 that is integrated with an ignitor, and the like. Additionally, the above signals may also include a control signal to a variable valve timing mechanism 150 capable of changing the opening/closing timing of the intake valve 128, a driving signal to the fuel pump 62, a driving signal to the magnetic valve 64a of the high-pressure fuel pump 64, a driving signal to the relief valve 67, and the like.

Additionally, the engine ECU 24 calculate the rotation speed Ne of the engine 22 on the basis of the crank position Ocr from the crank position sensor 140, or calculates the volume efficiency (the ratio of volume of air actually taken in one cycle to stroke volume per one cycle of the engine 22) KL, on the basis of the intake air quantity Qa from the air flow meter 148 and the rotation speed Ne of the engine 22.

As illustrated in FIG. 1, the planetary gear 30 is constituted as a single pinion type planetary gear mechanism. A rotor of the motor MG1 is connected to a sun gear of the planetary gear 30. A driving shaft 36 coupled to driving wheels 38a, 38b via a differential gear 37 is connected to a ring gear of the planetary gear 30. The crankshaft 26 of the engine 22 is connected to a carrier of the planetary gear 30 via a damper 28.

The motor MG1 is constituted as, for example, a synchronous generator motor, and as described above, the rotor thereof is connected to the sun gear of the planetary gear 30. The motor MG2 is constituted as, for example, a synchronous generator motor, and a rotor thereof is connected to the driving shaft 36. The inverters 41, 42 are used for driving the motors MG1, MG2, and are connected to the battery 50 via a power line 54. The motors MG1, MG2 are rotationally driven by controlling switching of a plurality of switching elements (not illustrated) of the inverters 41, 42 using an electronic control unit 40 for motors (hereinafter referred to as a “motor ECU”).

Although not illustrated, the motor ECU 40 is constituted as a microprocessor centered on a CPU, and includes, in addition to the CPU, a ROM that stores a processing program, a RAM that temporarily stores data, input and output ports, and communication ports. Signals from various sensors required to control the driving of the motors MG1, MG2, for example, rotational positions θm1, θm2 from rotational position detecting sensors 43, 44 that detect the rotational positions of the rotors of the motors MG1, MG2, and the like are input to the motor ECU 40 via the input ports. Switching control signals or the like to the plurality of switching elements (not illustrated) of the inverters 41, 42 are output from the motor ECU 40 via the output ports. The motor ECU 40 is connected to the HVECU 70 via the communication ports. In addition, the motor ECU 40 calculates the rotation speeds Nm1, Nm2 of the motors MG1, MG2, on the basis of the rotational positions θm1 and θm2 of the rotors of the motors MG1, MG2 from the rotational position detecting sensors 43, 44.

The battery 50 is constituted as, for example, a lithium ion secondary battery or a nickel hydrogen secondary battery, and is connected to the inverters 41, 42 via the power line 54. The battery 50 is managed by the electronic control unit 52 for a battery (hereinafter referred to as a “battery ECU”).

Although not illustrated, the battery ECU 52 is constituted as a microprocessor centered on a CPU, and includes, in addition to the CPU, a ROM that stores a processing program, a RAM that temporarily stores data, input and output ports, and communication ports. Signals from various sensors required to manage the battery 50, for example, a voltage Vb from a voltage sensor 51a attached between terminals of the battery 50, an electric current Ib from a current sensor 51b attached to an output terminal of the battery 50, and the like are input to the battery ECU 52 via the input ports. The battery ECU 52 is connected to the HVECU 70 via the communication ports. The battery ECU 52 calculates a power storage rate SOC, on the basis of an integrated value of the battery current Ib from the current sensor 51b. The power storage rate SOC is a rate of the capacity of power that is dischargeable from the battery 50 to the total capacity of the battery 50.

Although not illustrated, the HVECU 70 is constituted as a microprocessor centered on a CPU, and includes, in addition to the CPU, a ROM that stores a processing program, a RAM that temporarily stores data, input and output ports, and communication ports. Signals from various sensors are input to the HVECU 70 via the input ports. The signals to be input to the HVECU 70 may include, for example, an ignition signal from an ignition switch 80, a shift position SP from a shift position sensor 82, and the like. Additionally, the above signals may include an accelerator opening degree Ace from an accelerator pedal position sensor 84, a brake pedal position BP from a brake pedal position sensor 86, a vehicle speed V from a vehicle speed sensor 88, and the like. The HVECU 70, as described above, is connected to the engine ECU 24, the motor ECU 40, the battery ECU 52 via the communication ports.

The hybrid vehicle 20 of the embodiment configured in this way performs driving in a hybrid driving (HV driving) mode or an electric driving (EV driving) mode. Here, the HV driving mode is a mode in which driving is performed with the operation of the engine 22, and the EV driving mode is a mode in which driving is performed without the operation of the engine 22.

In the HV driving mode, the HVECU 70 first sets a required torque Tp* of the driving shaft 36 on the basis of the accelerator opening degree Ace and the vehicle speed V, and calculates a required power Pp* that is obtained by multiplying the set required torque Tp* by the rotation speed Np of the driving shaft 36 and is required of driving. Here, as the rotation speed Np of the driving shaft 36, for example, a rotation speed obtained by multiplying the rotation speed Nm2 or the vehicle speed V of the motor MG2 by a conversion factor can be used. Subsequently, a required power Pe* required for the vehicle is calculated by subtracting a required charge/discharge power Pb* (a positive value when the battery 50 is discharged) based on State Of Charge (SOC) of the battery 50 from the required power Pp*. Then, a target rotation speed Ne* and a target torque Te* in the engine 22 and torque commands Tm1*, Tm2* of the motors MG1, MG2 are set such that the required power Pe* is output from the engine 22 and the required torque Tp* is output to the driving shaft 36. Then, the target rotation speed Ne* and the target torque Te* in the engine 22 are transmitted to the engine ECU 24, and the torque commands Tm1*, Tm2* of the motors MG1, MG2 are transmitted to the motor ECU 40. The engine ECU 24 performs the intake air quantity control, fuel injection control, ignition control, and the like of the engine 22 such that the engine 22 is operated on the basis of the target rotation speed Ne* and the target torque Te*, if the target rotation speed Ne* and the target torque Te* of the engine 22 are received. If the torque commands Tm1*, Tm2* of the motors MG1, MG2 are received, the motor ECU 40 controls switching of the plurality of switching elements of the inverters 41, 42 such that the motors MG1, MG2 are driven by the torque commands Tm1*, Tm2*. In this HV driving mode, when the stop conditions of the engine 22 are established, such as when the required power Pe* reaches a value equal to or smaller than a stopping threshold value Pstop, the operation of the engine 22 is stopped, and shift to the EV driving mode is made.

In the EV driving mode, the HVECU 70 sets the required torque Tp* of the driving shaft 36 on the basis of the accelerator opening degree Acc and the vehicle speed V, sets a value 0 to the torque command Tm1* of the motor MG1 and sets the required torque Tp* to the torque command Tm2* of the motor MG2, and transmits the torque command Tm1*, Tm2* of the motors MG1, MG2 to the motor ECU 40. If the torque commands Tm1*, Tm2* of the motors MG1, MG2 are received, the motor ECU 40 controls switching of the plurality of switching elements of the inverters 41, 42 such that the motors MG1, MG2 are driven by the torque commands Tm1*, Tm2*. In this EV driving mode, for example, when the starting conditions of the engine 22 are satisfied, such as when the required power Pe* calculated similar to the HV driving mode reaches a value equal to or larger than a starting threshold value Pstart larger than the stopping threshold value Pstop, the engine 22 is started, and shift to the HV driving mode is made.

The starting of the engine 22 is performed as follows by the cooperative control among the HVECU 70, the engine ECU 24, and the motor ECU 40. First, the engine 22 is cranked by outputting a cranking torque for cranking the engine 22 from the motor MG1, and outputting a summed torque of a canceling torque for canceling the torque acting on the driving shaft 36 with the output of this cranking torque, and the required torque Tp* from motor MG2. Then, when the rotation speed Ne of the engine 22 reaches a value equal to or larger than a predetermined rotation speed, the operation of the engine 22, such as the fuel injection control and the ignition control, is started. In the rotation speed Ne of the engine 22 in the present embodiment, for example, the predetermined rotation speed is 500 rpm, 600 rpm, 700 rpm, or the like.

Here, the operation control, particularly the intake air quantity control and the fuel injection control of the engine 22 will be described. In the intake air quantity control, a target air quantity Qa* is set on the basis of the target torque Te*, a target throttle opening degree TH* is set such that the intake air quantity Qa reaches the target air quantity Qa* and the driving of the throttle motor 136 is controlled such that the throttle opening degree TH reaches the target throttle opening degree TH*. In the fuel injection control, first, for example, an execution injection mode is set from the port injection mode, the cylinder injection mode, and the common injection mode, on the basis of the operational state of the engine 22, such as the rotation speed Ne or the volume efficiency KL of the engine 22. Subsequently, target fuel injection quantities Qfd*, Qfp* of the in-cylinder injection valve 125 and the port injection valve 126 are set such that the air-fuel ratio AF reaches a target air-fuel ratio AF*, such as a theoretical air-fuel ratio, on the basis of the target air quantity Qa* and the execution injection mode. Then, target fuel injection durations τfd*, τfp* of the in-cylinder injection valve 125 and the port injection valve 126 are set on the basis of target fuel injection quantities Qfd*, Qfp*, and the driving of the in-cylinder injection valve 125 and the port injection valve 126 is controlled such that fuel injection during the target fuel injection durations τfd*, τfp* is performed from the in-cylinder injection valve 125 and the port injection valve 126.

The target fuel injection duration τfd* of the in-cylinder injection valve 125 is set on the basis of the target fuel injection quantity Qfd*, and a smoothened fuel pressure Pfs obtained by performing smoothing processing on the detected fuel pressure Pfdet from the fuel pressure sensor 69. Specifically, the target fuel injection duration τfd* is set such that the target fuel injection duration τfd* when the target fuel injection quantity Qfd* is large becomes long as compared to that when the target fuel injection quantity Qfd* is small, and the target fuel injection duration τfd* when the smoothened fuel pressure Pfs is high becomes shorter as compared to that when the smoothened fuel pressure Pfs is low. In detail, the target fuel injection duration τfd* is set so as to become longer as the target fuel injection quantity Qf* is larger and become shorter as the smoothened fuel pressure Pfs is higher. The target fuel injection quantity τfp* of the port injection valve 126 is set on the basis of the target fuel injection quantity Qfp*. Specifically, the target fuel injection duration τfp* is set such that the target fuel injection duration τfp* when the target fuel injection quantity Qfp* is large becomes long as compared to that when the target fuel injection quantity Qfp* is small. In detail, the target fuel injection duration τfp* is set so as to become longer as the target fuel injection quantity Qf* is larger.

Additionally, when the engine 22 is operated, the driving of the high-pressure fuel pump 64 (the magnetic valve 64a) is controlled such that the detected fuel pressure Pfdet reaches the target fuel pressure Pf*. Here, the target fuel pressure Pf* is determined as a value at which fuel can be appropriately injected from the in-cylinder injection valve 125 in the cylinder injection mode or the common injection mode. As the target fuel pressure Pf*, for example, a constant value, such as 15 MPa, 16 MPa, or 17 Mpa may be used. Additionally, the target fuel pressure Pf* until fuel injection of a predetermined number of times (or the like), such as one time, two times, or three times, is completed from the in-cylinder injection valve 125 to each cylinder after the operation of the engine 22 is started is defined as a fuel pressure Pf1 (for example, 9 MPa, 10 MPa, 11 MPa, or the like), and the target fuel pressure Pf* after that is defined as a fuel pressure Pf2 (for example, 15 MPa, 16 MPa, 17 Mpa, or the like) higher than the fuel pressure Pf1. In addition, in the embodiment, the fuel injection control is performed by setting the cylinder injection mode to the execution injection mode until a certain amount of time passes from the start of operation of the engine 22. In addition, the driving of the high-pressure fuel pump 64 (magnetic valve 64a) may be controlled such that the smoothened fuel pressure Pfs reaches the target fuel pressure Pf*.

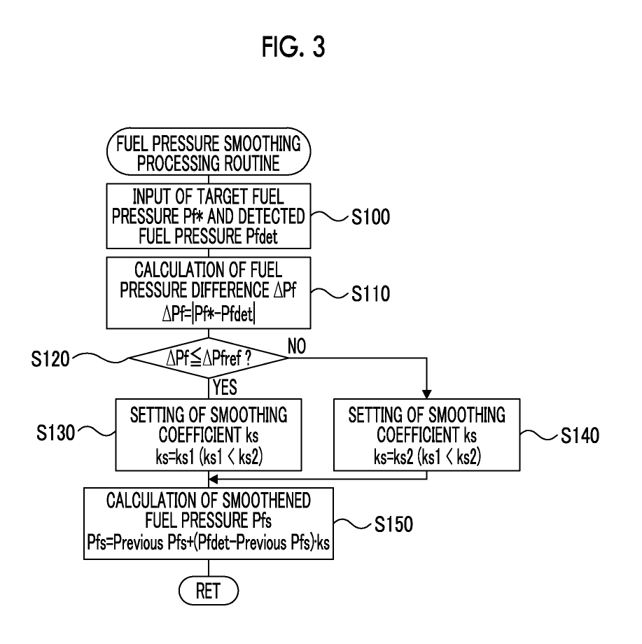

Next, the operation of the hybrid vehicle 20 of the embodiment configured in this way, particularly, the operation when the smoothened fuel pressure Pfs is calculated by performing smoothing processing on the detected fuel pressure Pfdet from the fuel pressure sensor 69 will be described. FIG. 3 is a flowchart illustrating an example of a fuel pressure smoothing processing routine to be executed by the engine ECU 24 of the embodiment. This routine is repeatedly executed at every predetermined time (for example, every several milliseconds) during the operation of the engine 22.

If the fuel pressure smoothing processing routine is executed, first, the engine ECU 24 inputs the target fuel pressure Pf*, and the detected fuel pressure Pfdet from the fuel pressure sensor 69 (Step S100), and calculates an absolute value of a value, which is obtained by subtracting the detected fuel pressure Pfdet from the target fuel pressure Pf*, as a fuel pressure difference ΔPf (Step S110).

Subsequently, the fuel pressure difference ΔPf is compared with a threshold value ΔPfref (Step S120). Here, the threshold value ΔPfref is a threshold value used in order to determine whether or not the fuel pressure difference ΔPfref is relatively small, for example, 0.8 MPa, 1.0 MPa, 1.2 MPa, or the like can be used.

When the fuel pressure difference ΔPf is equal to or smaller than the threshold value ΔPfref, it is determined that the fuel pressure difference ΔPf is relatively small, and a relatively small smoothing value ks1 (for example, ⅛, 1/9, or the like) is set to a smoothing coefficient ks used for smoothing processing of the detected fuel pressure Pfdet (Step S130). On the other hand, when the fuel pressure difference ΔPf is larger than the threshold value ΔPfref, a value ks2 (for example, ½, ⅓, or the like) larger than the smoothing value ks1 is set to the smoothing coefficient ks (Step S140).

Then, the smoothened fuel pressure Pfs is calculated by performing fuel pressure smoothing processing on the detected fuel pressure Pf according to the following Formula (1), using the detected fuel pressure Pfdet, the smoothing coefficient ks, and a smoothened fuel pressure (previous Pfs) calculated at the time of previous execution of a main routine (Step S150), and the main routine is ended.

Pfs=Previous Pfs+(Pfdet−Previous Pfs)·ks (1)

By calculating the smoothened fuel pressure Pfs, the followability of the smoothened fuel pressure Pfs with respect to the detected fuel pressure Pfdet when the fuel pressure difference ΔPf is larger than the threshold value ΔPfref becomes high as compared to that when the fuel pressure difference ΔPf is equal to or smaller than the threshold value ΔPfref.

As described above, the fuel pressure within the delivery pipe 66 pulsates according to the rotation (the rotation of the cam shaft) of the engine 22 around the target fuel pressure Pf* during the operation of the engine 22 (the operation thereof is continuing to some extent), and drops at the time of the stop of the engine 22 (for example, reaches about hundreds of kilopascals). Hence, it is believed that the fuel pressure within the delivery pipe 66 immediately after the start of operation of the engine 22 is sufficiently low as compared to the target fuel pressure Pf*, and the fuel pressure within the delivery pipe 66 rises rapidly (at a large rising rate) while pulsating due to the driving of the high-pressure fuel pump 64, and reaches the vicinity of the target fuel pressure Pf*.

It can be believed from above that when the fuel pressure difference ΔPf is larger than the threshold value ΔPfref is when the fuel pressure within the delivery pipe 66 is rapidly raised while being pulsated by the high-pressure fuel pump 64 by starting the operation of the engine 22. Additionally, since the rotation speed Ne of the engine 22 is relatively low immediately after the start of operation of the engine 22, the cycle of pulsation of the fuel pressure within the delivery pipe 66 becomes long, and the pulsation of the fuel pressure is apt to become large. For these reasons, when the fuel pressure difference ΔPf is larger than the threshold value ΔPfref a discrepancy between the smoothened fuel pressure Pfs and an actual fuel pressure is apt to become large. If this discrepancy becomes large, the air-fuel ratio AF may be disturbed and the discharge amount of particulate matter may increase. In the embodiment, when the fuel pressure difference ΔPf is larger than the threshold value ΔPfref, the discrepancy between the smoothened fuel pressure Pfs and the actual fuel pressure can be made small by setting the smoothing coefficient ks to the value ks2 (making the followability of the smoothened fuel pressure Pfs with respect to the detected fuel pressure Pfdet relatively high). As a result, disturbance of the air-fuel ratio AF can be suppressed, and an increase in the discharge amount of particulate matter can be suppressed. Particularly, in the hybrid vehicle 20, driving is performed while the engine 22 is intermittently operated, and the frequency of switching between the operation and the stop of the engine 22 increases as compared to a vehicle that performs driving only using the power from the engine 22 without having the drive motor. Therefore, the importance of setting the smoothing coefficient ks in this way is larger.

It is believed that the pulsation of the fuel pressure within the delivery pipe 66 is also small to some extent because the detected fuel pressure Pfdet is around the target fuel pressure PP and the rotation speed Ne of the engine 22 is high to some extent, when the fuel pressure difference ΔPf is equal to or smaller than the threshold value ΔPfref. Hence, the pulsation of the smoothened fuel pressure Pfs resulting from the pulsation of the fuel pressure within the delivery pipe 66 can be further suppressed by setting the smoothing coefficient ks to the value ks1 (making the followability of the smoothened fuel pressure Pfs with respect to the detected fuel pressure Pfdet relatively low). As a result, fluctuation of the target fuel injection duration τfd* can be suppressed, and disturbance of the air-fuel ratio AF can be suppressed, and an increase in the discharge amount of particulate matter can be suppressed.

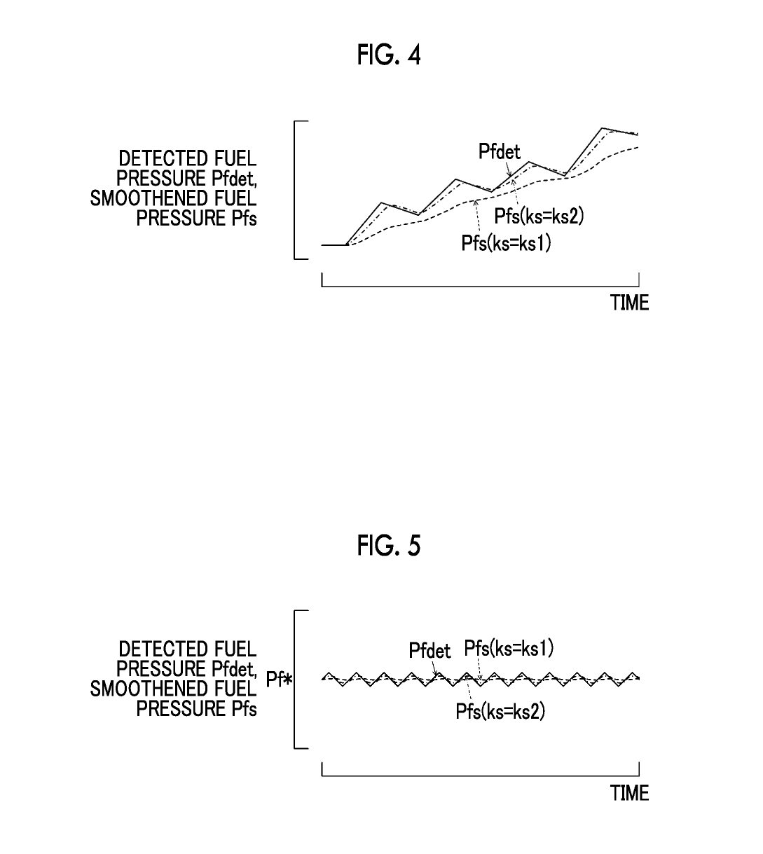

FIG. 4 is an explanatory view illustrating an aspect when the detected fuel pressure Pfdet is sufficiently low as compared to the target fuel pressure Pf* (the fuel pressure difference ΔPf is larger than the threshold value Pfref), and the detected fuel pressure Pfdet rises rapidly while pulsating. FIG. 5 is an explanatory view illustrating an aspect when the detected fuel pressure Pfdet pulsates around the target fuel pressure Pf* (when the fuel pressure difference ΔPf is equal to or smaller than the threshold value ΔPfref). In FIGS. 4 and 5, a solid line shows a state of the detected fuel pressure Pfdet, a dashed line shows a state of the smoothened fuel pressure Pfs when the value ks1 is set to the smoothing coefficient ks, and a one-dot chain line shows a state of the smoothened fuel pressure Pfs when the value ks2 is set to the smoothing coefficient ks. In the embodiment, since the value ks2 is used for the smoothing coefficient ks (refer to the one-dot chain line of FIG. 4) when the fuel pressure difference ΔPf is larger than the threshold value Pfref, the discrepancy between the smoothened fuel pressure Pfs and the actual fuel pressure can be made small, and an increase in the discharge amount of particulate matter can be increased. In the embodiment, since the value ks1 is used for the smoothing coefficient ks (refer to the dashed line of FIG. 5) when the fuel pressure difference ΔPf is equal to or smaller than the threshold value Pfref, pulsation of the smoothened fuel pressure Pfs can be further suppressed, and an increase in the discharge amount of particulate matter can be increased.

In the hybrid vehicle 20 of the embodiment described above, the smoothened fuel pressure Pfs is set by performing the smoothing processing on the detected fuel pressure Pf such that the followability of the smoothened fuel pressure Pfs with respect to the detected fuel pressure Pfdet when the fuel pressure difference ΔPf of the target fuel pressure Pf* of the fuel to supplied to the in-cylinder injection valve 125 and the detected fuel pressure Pfdet is larger than the threshold value ΔPfref after the operation of the engine 22 is started becomes higher as compared to that when the fuel pressure difference ΔPf is equal to or smaller than the threshold value ΔPfref. Accordingly, when the fuel pressure difference ΔPf is larger than the threshold value ΔPfref, that is, when it is believed that the operation of the engine 22 is started and the fuel pressure within the 26 delivery pipe 66 is rapidly raised while being pulsated by the high-pressure fuel pump 64, the discrepancy between the smoothened fuel pressure Pfs and the actual fuel pressure can be made small, and an increase in the discharge amount of particulate matter can be suppressed. In the embodiment, when the fuel pressure difference ΔPf is equal to or smaller than the threshold value Pfref, pulsation of the smoothened fuel pressure Pfs can be further suppressed, and an increase in the discharge amount of particulate matter can be suppressed.

In the hybrid vehicle 20 of the embodiment, when the fuel pressure difference ΔPf is equal to or smaller than the threshold value ΔPfref, the value ks1 is set to the smoothing coefficient ks, and when the fuel pressure difference ΔPf is larger than the threshold value ΔPfref, the value ks2 larger than the smoothing value ks1 is set to the smoothing coefficient ks. However, if the smoothing coefficient ks when the fuel pressure difference ΔPf is large is set to become large as compared to that when the fuel pressure difference ΔPf is small, the disclosure is not limited to the smoothing coefficient ks being switched in two steps according to the fuel pressure difference ΔPf. For example, the smoothing coefficient ks may be switched in three steps, four steps, five steps, or the like according to the fuel pressure difference ΔPf. Additionally, the smoothing coefficient ks may be changed in a straight line or a curved line according to the fuel pressure difference ΔPf.

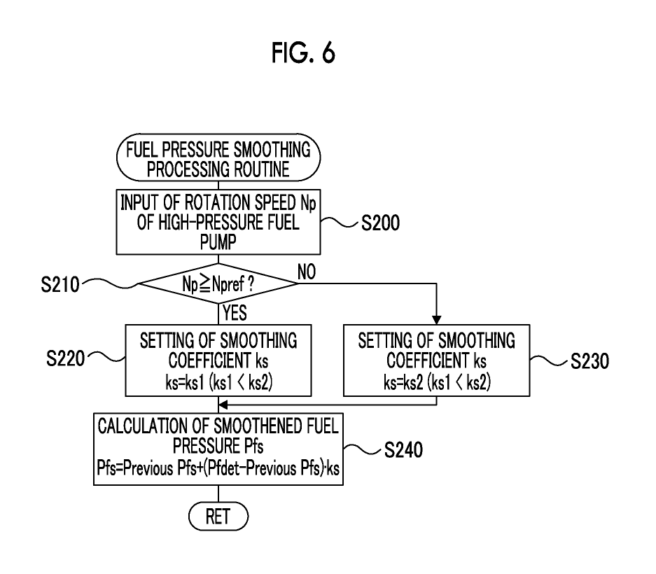

In the hybrid vehicle 20 of the embodiment, the smoothing coefficient ks used for smoothing processing of the detected fuel pressure Pfdet is set on the basis of the fuel pressure difference ΔPf. However, the smoothing coefficient ks may be set on the basis of the rotation speed Np of the high-pressure fuel pump 64. The fuel pressure smoothing processing routine in this case is illustrated in FIG. 6.

If the fuel pressure smoothing processing routine of FIG. 6 is executed, the rotation speed Np of the high-pressure fuel pump 64 from the rotation speed sensor 64c is input (Step S200), and the input rotation speed Np of the high-pressure fuel pump 64 is compared with a threshold value Npref (Step S210). Here, as the threshold value Npref, the rotation speed Np of the high-pressure fuel pump 64 equivalent to an idle rotation speed Neid1 (for example, 900 rpm, 1000 rpm, 1100 rpm, or the like) that is the rotation speed Ne of the engine 22 when the engine 22 is operated in an idling manner, a rotation speed slightly lower than the rotation speed Np, or the like can be used.

When the rotation speed Np of the high-pressure fuel pump 64 is equal to or larger than the threshold value Npref, the value ks1 is set to the smoothing coefficient ks (Step S220), and when the rotation speed Np of the high-pressure fuel pump 64 is smaller than the threshold value Npref, the value ks2 larger than the value ks1 is set to the smoothing coefficient ks (Step S230). Then, similar to Step S150 of the fuel pressure smoothing processing routine of FIG. 3, the smoothened fuel pressure Pfs is calculated by performing fuel pressure smoothing processing on the detected fuel pressure Pf using the smoothing coefficient ks (Step S240), and a main routine is ended.

Here, it can be believed from above that when rotation speed Np of the high-pressure fuel pump 64 is smaller the threshold value Npref is when the fuel pressure within the delivery pipe 66 is rapidly raised while being pulsated by the high-pressure fuel pump 64 by starting the operation of the engine 22, similar to the fuel pressure difference ΔPf is larger than the threshold value ΔPfref. Hence, in this case, the discrepancy between the smoothened fuel pressure Pfs and the actual fuel pressure can be made small similar to the embodiment by setting the smoothing coefficient ks to the value ks2 (making the followability of the smoothened fuel pressure Pfs with respect to the detected fuel pressure Pfdet relatively high). As a result, disturbance of the air-fuel ratio AF can be suppressed, and an increase in the discharge amount of particulate matter can be suppressed.

Additionally, when the rotation speed Np of the high-pressure fuel pump 64 is equal to or larger than the threshold value Npref, the pulsation of the smoothened fuel pressure Pfs resulting from the pulsation of the fuel pressure within the delivery pipe 66 can be further suppressed by setting the smoothing coefficient ks to the value ks1 (making the followability of the smoothened fuel pressure Pfs with respect to the detected fuel pressure Pfdet relatively low). As a result, fluctuation of the target fuel injection duration τfd* can be suppressed, and disturbance of the air-fuel ratio AF can be suppressed, and an increase in the discharge amount of particulate matter can be suppressed.

In this modification example, when the rotation speed Np of the high-pressure fuel pump 64 is equal to or larger than the threshold value Npref, the value ks1 is set to the smoothing coefficient ks, and when the rotation speed Np of the high-pressure fuel pump 64 is smaller than the threshold value Npref, the value ks2 larger than the value ks1 is set to the smoothing coefficient ks. However, if the smoothing coefficient ks when the rotation speed Np of the high-pressure fuel pump 64 is slow is set to become large as compared to that when rotation speed Np of the high-pressure fuel pump 64 is fast, the disclosure is not limited to the smoothing coefficient ks being switched in two steps according to the rotation speed Np of the high-pressure fuel pump 64. For example, the smoothing coefficient ks may be switched in three steps, four steps, five steps, or the like according to the rotation speed Np of the high-pressure fuel pump 64. Additionally, the smoothing coefficient ks may be changed in a straight line or a curved line according to rotation speed Np of the high-pressure fuel pump 64.

In the hybrid vehicle 20 of the embodiment, the high-pressure fuel pump 64 is driven with the power from the engine 22, but may be driven by an electric motor.

Although the engine 22 having the in-cylinder injection valve 125 and the port injection valve 126 is used in the hybrid vehicle 20 of the embodiment, engines having only the in-cylinder injection valve without having the port injection valve may be used.

In the hybrid vehicle 20 of the embodiment, a 6-cylinder engine 22 is used. However, engines of 4 cylinders, 8 cylinders, 12 cylinders, and the like may be used.

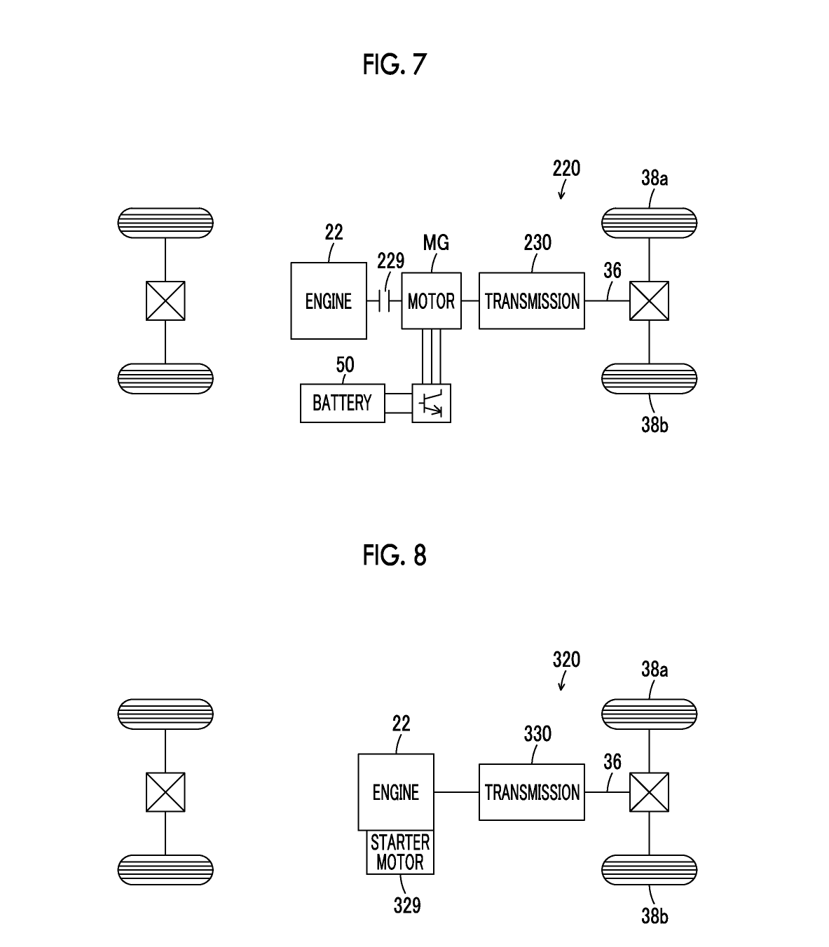

The hybrid vehicle 20 of the embodiment has a configuration in which the planetary gear 30 is connected to the engine 22, the motor MG1 and the driving shaft 36 coupled to the driving wheels 38a, 38b, and the motor MG2 is connected to the driving shaft 36. However, as illustrated in a hybrid vehicle 220 of a modification example of FIG. 7, a configuration in which a motor MG is connected to the driving shaft 36 coupled to the driving wheels 38a, 38b via a transmission 230, and the engine 22 is connected to a rotating shaft of the motor MG via a clutch 229 may be adopted.

The hybrid vehicle 20 of the embodiment has a configuration in which the planetary gear 30 is connected to the engine 22, the motor MG1 and the driving shaft 36 coupled to the driving wheels 38a, 38b, and the motor MG2 is connected to the driving shaft 36, and driving is performed while the engine 22 is intermittently operated. However, as illustrated in a vehicle 320 of a modification example of FIG. 8, a configuration in which with no drive motor is included, the engine 22 is connected to the driving shaft 36 coupled to the driving wheels 38a, 38b via a transmission 330, and a starter motor 329 is connected to the engine 22 via a one-way clutch (not illustrated) may be adopted. Even in this configuration, the same effects as the embodiment or the above-described modification example can be exhibited by setting the smoothing coefficient ks used for smoothing processing of the detected fuel pressure Pfdet on the basis of the fuel pressure difference ΔPf, and the rotation speed Np of the high-pressure fuel pump 64. Particularly, in vehicles that perform so-called idle stop control, the frequency of switching between the operation and the stop of the engine 22 increases compared to vehicles that do not perform the idle stop control. Therefore, the importance of setting the smoothing coefficient ks in this way is large.

Correspondence relationships between the main elements of the example and the main elements of the disclosure described in the column of the means for solving the problems will be described. In the embodiment, the engine 22 is equivalent to an “engine”, the fuel supply device 60 is equivalent to a “fuel supply device”, the fuel pressure sensor 69 is equivalent to a “fuel pressure sensor”, and the engine ECU 24, motor ECU 40, battery ECU 52 and HVECU 70 are equivalent to “ECU”.

In addition, since the correspondence relationships between the main elements of the embodiment and the main elements of the disclosure described in the summary are embodiments for specifically describing modes for carrying out the disclosure described in the column of the means for summary. Therefore the elements of the disclosure are not limited to the main elements of the embodiment. That is, interpretation about the disclosure described in the summary should be performed on the basis of the description of the summary, and the embodiment are merely specific embodiments of the disclosure described in the summary.

Although the modes for carrying out the disclosure have been described above using the embodiment, the disclosure is not limited to such embodiment at all, and can be naturally carried out in various forms without departing from the scope of the disclosure.

The disclosure is available for a vehicle manufacturing industry, and the like.

What is claimed is:

1. A control device for a vehicle, the vehicle including
an engine including an in-cylinder injection valve configured to inject fuel into a cylinder,
a fuel supply device including a high-pressure fuel pump configured to pressurize the fuel from a fuel tank to supply a pressurized fuel to a supply flow passage to which the in-cylinder injection valve is connected, and
a fuel pressure sensor configured to detect fuel pressure of the fuel in the in-cylinder injection valve as a detected fuel pressure,
the control device comprising
an electronic control unit configured to
i) control the high-pressure fuel pump such that the fuel pressure of the fuel in the in-cylinder injection valve reaches a target fuel pressure, during operation of the engine,
ii) perform smoothing processing on the detected fuel pressure to calculate a smoothened fuel pressure such that a followability of the smoothened fuel pressure with respect to a change in the detected fuel pressure when a difference between the target fuel pressure and the detected fuel pressure is large is higher than a followability of the smoothened fuel pressure with respect to a change in the detected fuel pressure when the difference between the target fuel pressure and the detected fuel pressure is small, during the operation of the engine,
iii) set a target fuel injection duration of the in-cylinder injection valve based on the smoothened fuel pressure during the operation of the engine, and
iv) control the engine such that fuel injection is performed from the in-cylinder injection valve during the target fuel injection duration.

2. The control device according to claim 1,
wherein the electronic control unit is configured to
i) set a smoothing coefficient such that a value of the smoothing coefficient when a difference between a target fuel pressure of the fuel to be supplied to the in-cylinder injection valve and the detected fuel pressure is larger than a threshold value is larger than a value of the smoothing coefficient when a difference between a target fuel pressure of the fuel to be supplied to the in-cylinder injection valve and the detected fuel pressure is equal to or smaller than the threshold value, and
ii) calculate the smoothened fuel pressure based on the smoothing coefficient.

3. The control device according to claim 1,
wherein the vehicle includes a drive motor, and the electronic control unit is configured to control the engine and the drive motor such that the vehicle travels while the engine performs intermittent operation.

4. A control device for a vehicle, the vehicle including
an engine including an in-cylinder injection valve configured to inject fuel into a cylinder,
a fuel supply device including a high-pressure fuel pump configured to pressurize the fuel from a fuel tank to supply a pressurized fuel to a supply flow passage to which the in-cylinder injection valve is connected, and
a fuel pressure sensor configured to detect fuel pressure of the fuel in the in-cylinder injection valve as a detected fuel pressure,
the control device comprising
an electronic control unit configured to
i) control the high-pressure fuel pump such that the fuel pressure of the fuel in the in-cylinder injection valve reaches a target fuel pressure, during operation of the engine,
ii) perform smoothing processing on the detected fuel pressure to calculate a smoothened fuel pressure such that a followability of the smoothened fuel pressure with respect to a change in the detected fuel pressure when a rotation speed of the high-pressure fuel pump is small is higher than a followability of the smoothened fuel pressure with respect to a change in the detected fuel pressure when the rotation speed of the high-pressure fuel pump is large during the operation of the engine,
iii) set a target fuel injection duration of the in-cylinder injection valve based on the smoothened fuel pressure, during the operation of the engine, and
iv) control the engine such that fuel injection is performed from the in-cylinder injection valve during the target fuel injection duration.

5. The control device according to claim 4,
wherein the electronic control unit is configured to
i) set a smoothing coefficient such that a value of the smoothing coefficient when a rotation speed of the high-pressure fuel pump is smaller than a threshold value is larger than a value of the smoothing coefficient when a rotation speed of the high-pressure fuel pump is equal to or larger than a threshold value, and
ii) calculate the smoothened fuel pressure based on the smoothing coefficient.

6. The control device according to claim 4,
wherein the vehicle includes a drive motor, and the electronic control unit is configured to control the engine and the drive motor such that the vehicle travels while the engine performs intermittent operation.

7. A control method for a vehicle, the vehicle including
an engine including an in-cylinder injection valve configured to inject fuel into a cylinder,
a fuel supply device including a high-pressure fuel pump configured to pressurize the fuel from a fuel tank to supply a pressurized fuel to a supply flow passage to which the in-cylinder injection valve is connected,
a fuel pressure sensor configured to detect fuel pressure of the fuel in the in-cylinder injection valve as a detected fuel pressure, and
an electronic control unit,
the control method comprising
i) controlling the high-pressure fuel pump by the electronic control unit such that the fuel pressure of the fuel in the in-cylinder injection valve reaches a target fuel pressure, during operation of the engine,
ii) performing smoothing processing on the detected fuel pressure to calculate a smoothened fuel pressure by the electronic control unit such that a followability of the smoothened fuel pressure with respect to a change in the detected fuel pressure when a difference between the target fuel pressure and the detected fuel pressure is large is higher than a followability of the smoothened fuel pressure with respect to a change in the detected fuel pressure when the difference between the target fuel pressure and the detected fuel pressure is small during the operation of the engine,
iii) setting a target fuel injection duration of the in-cylinder injection valve by the electronic control unit based on the smoothened fuel pressure, during the operation of the engine, and
iv) controlling the engine by the electronic control unit such that fuel injection is performed from the in-cylinder injection valve during the target fuel injection duration.

8. A control method for a vehicle, the vehicle including
an engine including an in-cylinder injection valve configured to inject fuel into a cylinder,
a fuel supply device including a high-pressure fuel pump configured to pressurize the fuel from a fuel tank to supply a pressurized fuel to a supply flow passage to which the in-cylinder injection valve is connected,
a fuel pressure sensor configured to detect fuel pressure of the fuel in the in-cylinder injection valve as a detected fuel pressure, and
an electronic control unit,
the control method comprising
i) controlling the high-pressure fuel pump by the electronic control unit such that the fuel pressure of the fuel in the in-cylinder injection valve reaches a target fuel pressure, during operation of the engine,
ii) performing smoothing processing on the detected fuel pressure to calculate a smoothened fuel pressure by the electronic control unit such that a followability of the smoothened fuel pressure with respect to a change in the detected fuel pressure when a rotation speed of the high-pressure fuel pump is small is higher than a followability of the smoothened fuel pressure with respect to a change in the detected fuel pressure when the rotation speed of the high-pressure fuel pump is large, during the operation of the engine,
iii) setting a target fuel injection duration of the in-cylinder injection valve by the electronic control unit based on the smoothened fuel pressure during the operation of the engine, and
iv) controlling the engine by the electronic control unit such that fuel injection is performed from the in-cylinder injection valve during the target fuel injection duration.
